(19) United States
(12) Patent Application Publication
(10) Pub. No.: US 2017/0299928 A1
(43) Pub. Date: Oct. 19, 2017

(54) LIQUID CRYSTAL DISPLAY PANEL AND DISPLAY DEVICE

(71) Applicant: Shenzhen China Star Optoelectronics Technology Co. Ltd., Shenzhen City (CN)

(72) Inventors: Xia ZHANG, Shenzhen (CN); Hsiaohsien CHEN, Shenzhen (CN)

(21) Appl. No.: 15/120,754

(22) PCT Filed: May 17, 2016
(86) PCT No.: PCT/CN2016/082283

§ 371 Date: Aug. 23, 2016

(30) Foreign Application Priority Data
Apr. 19, 2016 (CN) 201610244340.8

(51) Int. Cl. G02F 1/1362; G02F 1/1368; G02F 1/1339

(52) U.S. Cl. CPC G02F 1/136209; G02F 1/136286; G02F 1/1368; G02F 1/13394; G02F 2001/13398; G02F 2001/136222; G02F 2001/13396

(57) ABSTRACT

A liquid crystal display panel and a display device are provided. A groove portion and a non-groove portion are disposed in the flat layer corresponding to the scan lines in the liquid crystal display panel. A spacer member includes a plurality of main spacers disposed on the black matrix corresponding to the non-groove portion, and a plurality of sub-spacers disposed on the black matrix corresponding to the groove portion. The present invention provides the liquid crystal display panel with the advances of a short process time and a simple process.

### FIELD OF THE INVENTION

The present invention relates to a technical field of displays, and in particular to a liquid crystal display panel, and a display device utilizing the liquid crystal display panel.

### BACKGROUND OF THE INVENTION

Color Filter On Array (COA) is an integrated technology for integrating color filters and thin film transistor array substrates. A COA compared with a traditional liquid crystal display panel has a larger aperture ratio.

In a traditional liquid crystal display panel of a COA, the black matrix and the spacer member are formed respectively, and the process time is too long. The spacer member has main spacers and sub-spacers. When the main spacers and the sub-spacers are formed, it is necessary to rigorously set the transmittance, exposure time, and exposure to ensure that the main spacers and the sub-spacers are formed with different heights. Thus the process of forming the liquid crystal display panel is lengthened and complicated.

### SUMMARY OF THE INVENTION

An object of the present invention is to provide a liquid crystal display panel, and a display device utilizing the liquid crystal display panel, which solves the problem of the long process time since the black matrix and the spacer member are formed respectively, and complex process due to forming the main spacers and the sub-spacers with different heights.

To achieve the above objects, the present invention provides a liquid crystal display panel, the liquid crystal display panel comprises a display substrate, scan lines, thin film transistors, a color resist layer, a flat layer, a black matrix, and a spacer member; the scan lines are disposed on the substrate; the thin film transistors are disposed on the scan lines; the color resist layer is disposed on the thin film transistors and includes blue resists, red resists, and green resists; the flat layer is disposed on the color resist layer, wherein a groove portion and a non-groove portion are disposed in the flat layer corresponding to the scan lines, and the flat layer is made of a negative photoresist material; the black matrix is disposed on the flat layer aligned to the scan lines; the spacer member includes a plurality of main spacers disposed on the black matrix corresponding to the non-groove portion for supporting the display substrate and a counter substrate corresponding to the display substrate to keep a distance between the display substrate and the counter substrate, and a plurality of sub-spacers disposed on the black matrix corresponding to the groove portion for supporting the display substrate adjunctively when the display substrate is forced by an external pressure, wherein the main spacers are protruded from the sub-spacers, and the sub-spacers are protruded from the black matrix corresponding to the non-groove portion.

In one embodiment of the present invention, the black matrix and the spacer member are made of the same material.

In one embodiment of the present invention, the black matrix and the spacer member are simultaneously formed through a lithography process with a halftone mask or a gray tone mask.

In one embodiment of the present invention, a height of the main spacer protruded from the sub-spacer is ranged from 0.2 μm to 1 μm.

In one embodiment of the present invention, a height of the sub-spacer protruded from the black matrix is not greater than 2.3 μm.

In one embodiment of the present invention, a distribution density of the main spacers and the sub-spacers on the liquid crystal display panel is one main spacer and twenty four sub-spacers disposed in each of eight pixels.

In one embodiment of the present invention, the sub-spacers are corresponding to the resists of the color resist layer, respectively.

In one embodiment of the present invention, the main spacers are disposed on the black matrix corresponding to the non-groove portion above the blue resists.

In one embodiment of the present invention, a difference between a thickness of the non-groove portion and a thickness of the groove portion in the flat layer is ranged from 0.25 μm to 1 μm.

In one embodiment of the present invention, a shape of the groove portion is rectangular, square, or cylindrical.

To achieve the above object, the present invention provides a liquid crystal display panel, the liquid crystal display panel comprises a display substrate, scan lines, thin film transistors, a color resist layer, a flat layer, a black matrix, and a spacer member; the scan lines are disposed on the substrate; the thin film transistors are disposed on the scan lines; the color resist layer is disposed on the thin film transistors; the flat layer is disposed on the color resist layer, wherein a groove portion and a non-groove portion are disposed in the flat layer corresponding to the scan lines; the black matrix is disposed on the flat layer aligned to the scan lines; the spacer member includes a plurality of main spacers disposed on the black matrix corresponding to the non-groove portion for supporting the display substrate and a counter substrate corresponding to the display substrate to keep a distance between the display substrate and the counter substrate, and a plurality of sub-spacers disposed on the black matrix corresponding to the groove portion for supporting the display substrate adjunctively when the display substrate is forced by an external pressure, wherein the main spacers are protruded from the sub-spacers, and the sub-spacers are protruded from the black matrix corresponding to the non-groove portion.

In one embodiment of the present invention, the black matrix and the spacer member are made of the same material.

In one embodiment of the present invention, the black matrix and the spacer member are simultaneously formed through a lithography process with a halftone mask or a gray tone mask.

In one embodiment of the present invention, a height of the main spacer protruded from the sub-spacer is ranged from 0.2 μm to 1 μm.

In one embodiment of the present invention, a height of the sub-spacer protruded from the black matrix is not greater than 2.3 μm.

In one embodiment of the present invention, a difference between a thickness of the non-groove portion and a thickness of the groove portion in the flat layer is ranged from 0.25 μm to 1 μm.

In one embodiment of the present invention, a distribution density of the main spacers and the sub-spacers on the liquid crystal display panel is one main spacer and twenty four sub-spacers disposed in each eight of pixels.

In one embodiment of the present invention, the sub-spacers are corresponding to the resists of the color resist layer, respectively.

In one embodiment of the present invention, a shape of the groove portion is rectangular, square, or cylindrical.

The present invention further provides a display device, which comprises each of the above described liquid crystal display panels.

The preferred embodiment of the present invention provides a liquid crystal display panel, which compared with a traditional liquid crystal display panel, the flat layer corresponding to the scan lines has a non-groove portion and a groove portion. The main spacers are formed on the black matrix corresponding to the non-groove portion, and the sub-spacers are formed on the black matrix corresponding to the groove portion. A difference between a height of the main spacer and a height of the sub-spacer can be implemented through forming a difference between a thickness of the non-groove portion and a thickness of the groove portion. The black matrix, the main spacers and the sub-spacers of the liquid crystal display panel of the present invention are simultaneously formed through a lithography process, so that the process time of the liquid crystal display panel can be reduced and simplified.

The present invention further provides a display device, wherein the display device adopts the liquid crystal display panel, thus the process can be simplified, and the production cost can be reduced.

### DESCRIPTION OF THE DRAWINGS

FIG. 1 is a schematic view of a liquid crystal display panel.

FIG. 2 is a cross-sectional view of FIG. 1 from dotted line.

### DETAILED DESCRIPTION OF THE PREFERRED EMBODIMENTS

In order to more clearly illustrate the embodiments of the present invention, or the embodiments of the technical solutions of the prior art, will implement the following figures for the cases described in the prior art or require the use of a simple introduction. The following description of the drawings are only some embodiments of the present invention, those of ordinary skill in terms of creative effort without precondition, but also according to these figures derive other drawings.

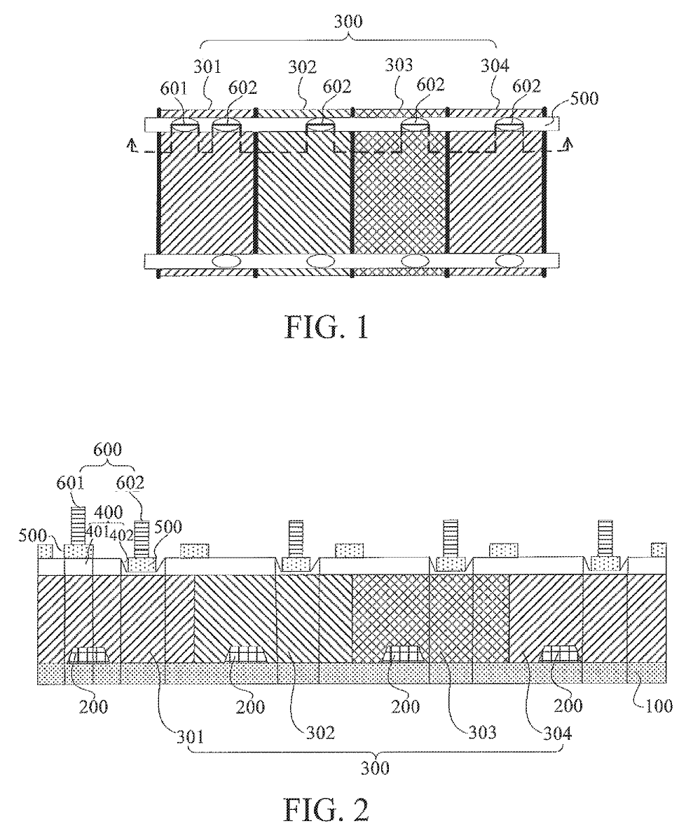

FIG. 1 is a schematic view of a liquid crystal display panel. FIG. 2 is a cross-sectional view of FIG. 1 from dotted line.

Below with reference to the FIG. 1 and FIG. 2 a structure of the liquid crystal display panel of a preferred embodiment is described in detail.

Refer to FIG. 2, the liquid crystal display panel 100 of the preferred embodiment includes a display substrate 100, and scan lines (not shown) disposed on the display substrate 100; one skilled in the art can know the position of the scan lines according to FIG. 1 and common knowledge of the liquid crystal display panel. Thin film transistors 200 are disposed on the scan lines, and a color resist layer 300 is disposed on the thin film transistors 200. The color resist layer 300 includes blue resists 301, red resists 302, and green resists 303, and resists 304, wherein the resists 304 could be white resists, or one of the blue resists, red resists, and green resists, but is not limited to this.

The flat layer 400 is disposed on the color resist layer 300, a non-groove portion 401 and a groove portion 402 are disposed in the flat layer 400 corresponding to the scan lines. It is easy to understand by combining FIG. 1 and FIG. 2 that the black matrix 500 is disposed on the flat layer 400 aligned to the scan lines in FIG. 2, a display area of the liquid crystal display panel locates the other place of the flat layer.

When the groove portion 402 and the non-groove portion 401 are disposed in the flat layer corresponding to the scan lines. A material of the flat layer is coated on the color resist layer 300, and a halftone mask is put on the flat layer corresponding to the scan lines, and the material of the flat layer is a negative photoresist material. In the halftone mask, a transmittance of a part of halftone mask is 50%, and a transmittance of another part of halftone mask is 100%. A thickness of the flat layer formed in 50% transmittance is small, and a thickness of the flat layer formed in 100% transmittance is large in the same exposure intensity. The negative photoresist material disposed in the flat layer corresponding to the scan lines is washed, so that a plurality of rectangular groove structures are formed on the flat layer corresponding to the scan lines, the groove structures of the flat layer are indicated the groove portion 402 of the flat layer 400 corresponding to the scan lines, and non-groove structures of the flat layer are more flat and indicate the non-groove portion 401 of the flat layer 400 corresponding to the scan lines.

In another embodiment, the flat layer is also disposed by a gray tone mask, the groove portion and the non-groove portion with different thickness are formed by adjusting a transmittance of a part of the gray tone mask. In the preferred embodiment, a difference between a thickness of the non-groove portion 401 and a thickness of the groove portion 402 is ranged from 0.25 μm to 1 μm, and a shape of the groove portion is rectangular, square, or cylindrical, but is not limited to this.

It should be appreciated that the distribution of the groove and the number of the groove structures can be disposed by setting 50% transmittance of the gray tone mask, the groove structures can be periodically arranged or can be aperiodically arranged, and are not limited to this. In the preferred embodiment, a groove portion 402 is disposed on the flat layer corresponding to each of the resist in the color resist layer 300.

The black matrix 500 is disposed on the flat layer 400. It should be appreciated, the black matrix 500 is disposed on the non-groove portion 401 and groove portion 402 by according a structure of the flat layer 400 corresponding to the scan lines.

A spacer member 600 is disposed on the black matrix 500, which comprises a plurality of main spacers 601 and a plurality of sub-spacers 602. The main spacers 601 are disposed on the black matrix 500 corresponding to the non-groove portion 401 for supporting the display substrate 100 and a counter substrate corresponding to the display substrate 100 to keep a distance between the display substrate 100 and the counter substrate. The sub-spacers 602 are disposed on the black matrix 500 corresponding to the groove portion 402 for supporting the display substrate adjunctively when the display substrate is forced by an external pressure.

The spacer member 600 needs to be protruded from the black matrix 500 to support the display substrate. The main spacers 601 are disposed on the black matrix 500 corresponding to the non-groove portion 401, and protruded from the black matrix 500. The sub-spacers 602 are disposed on the black matrix 500 corresponding to the groove portion 402, and protruded from the black matrix 500 corresponding to the groove portion 402, thus the sub-spacers 602 are higher than the black matrix 500 corresponding to the non-groove portion 401. The main spacers 601 provide a main support compared with the sub-spacers 602. Thus the main spacers 601 are protruded from the sub-spacers 602, and a height between the top of the main spacers 601 and the display substrate 100 is higher than a height between the top of the sub-spacers 602 and the display substrate 100.

In the preferred embodiment, a height of the main spacer 601 protruded from the sub-spacer 602 is ranged from 0.2 μm to 1 μm. A height of the sub-spacer protruded from the black matrix is not greater than 2.3 μm. For example, a height of the main spacer 601 protruded from the sub-spacer 602 is 0.9 μm, and a height of the sub-spacer 602 protruded from the black matrix 500 corresponding to the non-groove portion 401 is 1.1 μm.

In the preferred embodiment, the black matrix 500 and the spacer member are made of the same material, which provides an advantage in that a process of the black matrix 500 and a process of the spacer member 600 can be combined, and the black matrix 500 and the spacer member 600 can be formed simultaneously without processing two processes. A difference between a height of the main spacer 601 and a height of the sub-spacer 602 can be implemented through forming a difference between a thickness of the non-groove portion 401 and a thickness of the groove portion 402 in the flat layer 400 corresponding to the scan lines.

The material of the black matrix 500 has an effect of shielding light, and the material of the spacer member 600 has good elasticity. Thus a photosensitive resin composition is adopted to form the black matrix 500 and the spacer member 600 in the preferred embodiment, such as a photosensitive resin composition of Chinese Patent Application No: 201410143952.9 which has an effect of shielding light and good elasticity. In another embodiment, the black matrix 500 and the spacer member 600 can be formed by other materials, or the black matrix and the spacer member can be made of different material, but are not limited to this.

The photosensitive resin composition is coated on the flat layer 400 corresponding to the scan lines, and simultaneously formed through a lithography process with a halftone mask or a gray tone mask, so that the black matrix 500 and the spacer member 600 can be formed on the flat layer 400 corresponding to the scan lines. Specifically, the black matrix 500 is formed on the non-groove portion 401 of the flat layer 400 corresponding to the scan lines, a transmittance corresponding to the mask in a part of the black matrix 500 is large, and generates a strong exposure, so that a thickness the black matrix 500 is large, and the main spacers 601 are protruded. Similarly, the black matrix 500 is formed in the groove portion 402, a transmittance corresponding to the mask in another part of the black matrix 500 is large, and generates a strong exposure, so that a thickness the black matrix 500 is large, and the sub-spacers 602 are protruded.

In the preferred embodiment, the groove portion 402 is disposed on the flat layer corresponding to each of the resists of the color resist layer 300. It should be appreciated that the sub-spacers 602 are disposed on the black matrix 500 corresponding to each of the resists.

Preferably, a distribution density of the main spacers 601 and the sub-spacers 602 is one main spacer 601 disposed in each eight of pixels. The main spacers 601 is disposed on the black matrix 500 corresponding to the non-groove portion above the blue resists 301. The eight pixels comprise twenty four resists, and there are twenty four sub-spacers 602. The distribution of the main spacers 601 and the sub-spacers 602 is not one situation, and can be disposing according the actual requirements of the liquid crystal display panel, such as more main spacers 601 can be disposed in each eight of pixels.

In addition, the main spacers 601 can also be disposed on the red resists 302, green resists 303, or other resists, but are not limited to this.

The preferred embodiment of the present invention provides a liquid crystal display panel, the flat layer corresponding to the scan lines has two parts. Wherein one part is a non-groove portion, and the other part is a groove portion. There is a difference between a thickness of the non-groove portion and a thickness of the groove portion, and the black matrix and the spacer member are made of the same material. Thus the black matrix and the spacer member are simultaneously formed through a lithography process to reduce a process time of the liquid crystal display panel. The main spacers of spacer member are formed on the black matrix corresponding to the non-groove portion, and the sub-spacers are formed on the black matrix corresponding to the groove portion. A difference between a height of the main spacer and a height of the sub-spacer can be implemented through forming a difference between a thickness of the non-groove portion and a thickness of the groove portion in the flat layer. The preferred embodiment of the liquid crystal display panel compared with a traditional liquid crystal display panel has a more simple process, and the process time can be reduced to improve a productivity of the liquid crystal display panel.

The preferred embodiment of the present invention provides a display device, which comprises said liquid crystal display panel, the non-groove portion and the groove portion are disposed on the flat layer corresponding to the scan lines, which has a difference between a thickness of the non-groove portion and a thickness of the groove portion to form a difference between a height of the main spacer and a height of the sub-spacer. The black matrix and the spacer member are made of the same material, so that the black matrix and the spacer member are formed in a process to improve a productivity of the display device. The production cost can be reduced by forming the black matrix and the spacer member simultaneously.

The present invention has been described with preferred embodiments thereof and it is understood that many changes and modifications to the described embodiments can be carried out without departing from the scope and the spirit of the invention that is intended to be limited only by the appended claims.

What is claimed is:

1. A liquid crystal display panel, comprising:
a display substrate;
scan lines disposed on the substrate;
thin film transistors disposed on the scan lines;
a color resist layer disposed on the thin film transistors and including blue resists, red resists, and green resists;
a flat layer disposed on the color resist layer, wherein a groove portion and a non-groove portion are disposed in the flat layer corresponding to the scan lines, and the flat layer is made of a negative photoresist material;
a black matrix disposed on the flat layer aligned to the scan lines; and
a spacer member including a plurality of main spacers disposed on the black matrix corresponding to the non-groove portion for supporting the display substrate and a counter substrate corresponding to the display substrate to keep a distance between the display substrate and the counter substrate, and a plurality of sub-spacers disposed on the black matrix corresponding to the groove portion for supporting the display substrate adjunctively when the display substrate is forced by an external pressure, wherein the main spacers are protruded from the sub-spacers, and the sub-spacers are protruded from the black matrix corresponding to the non-groove portion.

2. The liquid crystal display panel according to claim 1, wherein the black matrix and the spacer member are made of the same material.

3. The liquid crystal display panel according to claim 2, wherein the black matrix and the spacer member are simultaneously formed through a lithography process with a halftone mask or a gray tone mask.

4. The liquid crystal display panel according to claim 1, wherein a height of the main spacer protruded from the sub-spacer is ranged from 0.2 μm to 1 μm.

5. The liquid crystal display panel according to claim 1, wherein a height of the sub-spacer protruded from the black matrix is not greater than 2.3 μm.

6. The liquid crystal display panel according to claim 1, wherein a distribution density of the main spacers and the sub-spacers on the liquid crystal display panel is one main spacer and twenty four sub-spacers disposed in each eight of pixels.

7. The liquid crystal display panel according to claim 6, wherein the sub-spacers are corresponding to the resists of the color resist layer, respectively.

8. The liquid crystal display panel according to claim 6, wherein the main spacers are disposed on the black matrix corresponding to the non-groove portion above the blue resists.

9. The liquid crystal display panel according to claim 1, wherein a difference between a thickness of the non-groove portion and a thickness of the groove portion in the flat layer is ranged from 0.25 μm to 1 μm.

10. The liquid crystal display panel according to claim 1, wherein a shape of the groove portion is rectangular, square, or cylindrical.

11. A liquid crystal display panel, comprising:
a display substrate;
scan lines disposed on the substrate;
thin film transistors disposed on the scan lines;
a color resist layer disposed on the thin film transistors;
a flat layer disposed on the color resist layer, wherein a groove portion and a non-groove portion are disposed in the flat layer corresponding to the scan lines;
a black matrix disposed on the flat layer aligned to the scan lines; and
a spacer member including a plurality of main spacers disposed on the black matrix corresponding to the non-groove portion for supporting the display substrate and a counter substrate corresponding to the display substrate to keep a distance between the display substrate and the counter substrate, and a plurality of sub-spacers disposed on the black matrix corresponding to the groove portion for supporting the display substrate adjunctively when the display substrate is forced by an external pressure, wherein the main spacers are protruded from the sub-spacers, and the sub-spacers are protruded from the black matrix corresponding to the non-groove portion.

12. The liquid crystal display panel according to claim 11, wherein the black matrix and the spacer member are made of the same material.

13. The liquid crystal display panel according to claim 12, wherein the black matrix and the spacer member are simultaneously formed through a lithography process with a halftone mask or a gray tone mask.

14. The liquid crystal display panel according to claim 11, wherein a height of the main spacer protruded from the sub-spacer is ranged from 0.2 μm to 1 μm.

15. The liquid crystal display panel according to claim 11, wherein a height of the sub-spacer protruded from the black matrix is not greater than 2.3 μm.

16. The liquid crystal display panel according to claim 11, wherein a difference between a thickness of the non-groove portion and a thickness of the groove portion in the flat layer is ranged from 0.25 μm to 1 μm.

17. The liquid crystal display panel according to claim 11, wherein a distribution density of the main spacers and the sub-spacers on the liquid crystal display panel is one main spacer and twenty four sub-spacers disposed in each eight of pixels.

18. The liquid crystal display panel according to claim 17, wherein the sub-spacers are corresponding to the resists of the color resist layer, respectively.

19. The liquid crystal display panel according to claim 11, wherein a shape of the groove portion is rectangular, square, or cylindrical.

20. A display device, comprising a liquid crystal display panel according to claim 11.
